(19) United States
(12) Patent Application Publication
(10) Pub. No.: US 2004/0081252 A1
(43) Pub. Date: Apr. 29, 2004

(54) Digital RF transmitter

(76) Inventor: Weichan Hsu, Los Altos, CA (US)

Correspondence Address: RABIN & Berdo, PC, 1101 14TH STREET, NW, SUITE 500, WASHINGTON, DC, 20005, US

(21) Appl. No.: 10/281,999

(22) Filed: Oct. 29, 2002

(51) Int. Cl. H04L 27/04; H04L 27/12

(52) U.S. Cl. 375/295

(57) ABSTRACT

A two-channel RF digital transmitter. The digital RF transmitter comprises a first and second digital modulator for receiving and modulating a first and second digital base-band signal from a first and second channel, a first and second local oscillator for generating a first and second digital carrier signal, a first and second mixer for receiving the first and second digital base-band and carrier signal and implementing multiplication of the first and second digital base-band and carrier signal to generate a first and second transmission signal, a first and second filter for band-pass filtering the first and second transmission signal respectively, and an adder for summing the filtered first and second transmission signal to generate a summation signal.

### BACKGROUND OF THE INVENTION

1. Field of the Invention

The present invention relates to a digital RF transmitter, particularly to a digital RF transmitter with IQ modulator.

2. Description of the Prior Art

FIG. 1 illustrates the functional diagram and the basic elements of a conventional digital communication system. The digital communication system comprises an information source and input transducer 11, source encoder 12, channel encoder 13, and digital modulator 14 at the transmitting end, and a digital demodulator 15, channel decoder 16, source decoder 17 and output transducer 18 at the receiving end. The signal is sent from the transmitting end to the receiving end through a channel 19. The communication channel is the physical medium that sends the signal from the transmitter to the receiver. In wireless transmission, the channel 19 may be the atmosphere (free space). The information source and input transducer 11 may output an analog signal, such as an audio or video signal, or a digital signal, such as the output of a teletype machine, discrete in time and having a finite number of output characters. The source encoder 12 implements the process of efficiently converting the signals output from the information source and input transducer 11 into a sequence of binary digits, called an information sequence. The purpose of the channel encoder 13 is to introduce, in a controlled manner, some redundancy in the binary information sequence that can be used at the receiver to overcome the effects of noise and interference encountered in the transmission of the signal through the channel 19. The digital modulator 14 serves as the interface to the communication channel 19. The primary purpose of the digital modulator 14 is to map the binary information sequence into signal waveforms.

At the receiving end of the digital communication system are a digital demodulator 15, channel decoder 16 and source decoder 17 to reconstruct the original signal from the source.

In the channel 19, low frequency signals cannot be transmitted through the atmosphere over a long distance. It is possible only when the low frequency signals are carried on RF carrier signals. Therefore, there must be an RF transmitter in the transmitting end of the digital communication system.

FIG. 2 is a diagram showing a conventional RF transmitter used in the transmitting end of the digital communication system. The RF transmitter comprises a D/A converter 21, a local oscillator 13, a mixer 25 and a power amplifier 27. The D/A converter 21 receives the digital base-band signal DBS with a baseband frequency f_{BB}, for example less than 10 MHz, and converts it into an analog base-band signal ABS. The local oscillator 23 generates an analog carrier signal ACS with a high Local oscillator frequency f_{LO}, for example 2.4 GHz or 5 GHz. The mixer 25 receives the analog base-band signal ABS and the analog carrier signal ACS, and implements signal multiplication thereof. This causes a frequency shift of the signal ABS in frequency domain and produces a semi-transmission signal STS. The semi-transmission signal STS is further amplified by the power amplifier 27 and then a transmission signal TS is transmitted by an antenna.

FIGS. 3a, 3b and 3c are diagrams showing the relation between the signals ABS, ACS and TS in frequency domain respectively. The signal ABS has a bandwidth BW (lower than 10 MHz) and a central frequency 0. The signal ACS has a frequency RF (for example, 2.4 GHz or 5 GHz). After being mixed with analog base-band signal ABS by the mixer 25, the signals ABS and ACS are mixed into the signal TS with the central frequency RF and bandwidth BW. Thus, the analog base-band signal ABS is carried on the analog carrier signal ACS and can be transmitted through the channel over a long distance.

However, there are some drawbacks in the conventional RF transmitter.

1. The operation of the D/A converter and mixer easily generates a lot of noise. Signal distortion also easily results from the nonlinear transformation of the converter 21 and mixer 25.

2. It requires much more effort for the circuit designers to design the layouts for the conventional RF transmitter composed of analog circuits.

### SUMMARY OF THE INVENTION

Therefore, the object of the present invention is to provide a digital RF transmitter more easily designed the layout for the corresponding digital circuit. A mixer in the digital RF transmitter simply implements multiplication of digital bits from signals and does not cause nonlinear transformation.

The present invention provides a digital RF digital transmitter. The transmitter comprises a first and second digital modulator for receiving and modulating a first and second digital base-band signal from a first and second channel, a first and second local oscillator for generating a first and second digital carrier signal, a first and second mixer for receiving the first and second digital base-band and carrier signal and implementing multiplication of the first and second digital base-band and carrier signal to generate a first and second transmission signal, a first and second filter for band-pass filtering the first and second transmission signal respectively, and an adder for summing the filtered first and second transmission signal to generate a summation signal.

The present invention further provides a method for RF digital transmission. The method comprises the step of receiving and modulating a first and second digital base-band signal from a first and second channel, the step of generating a first and second digital carrier signal, the step of receiving the first and second digital base-band and carrier signal, and the step of implementing multiplication of the first and second digital base-band and carrier signal to generate a first and second transmission signal, the step of band-pass filtering the first and second transmission signal respectively, and the step of summing the filtered first and second transmission signal to generate a summation signal.

The present invention also provides a digital RF transmitter. The transmitter comprises a first and second digital modulator for receiving and modulating a first and second N-bit digital base-band signal with a frequency fₛ from a first and second channel, and generating a first and second 1-bit modulated digital base-band signal with a frequency N×fₛ, a first and second local oscillator for generating a first and second digital carrier signal, a first and second digital mixer for receiving the first and second 1-bit modulated digital base-band signal and digital carrier signal, and implementing multiplication thereof to generate a first and second transmission signal, a first and second filter for band-pass filtering the first and second transmission signal respectively, and an adder for summing the filtered first and second transmission signal to generate a summation signal.

The present invention provides a method for RF digital transmission. The method comprises the step of receiving and modulating a first and second N-bit digital base-band signal with a frequency fₛ from a first and second channel, and generating a first and second 1-bit modulated digital base-band signal with a frequency N×fₛ, the step of generating a first and second digital carrier signal, the step of receiving the first and second 1-bit modulated digital base-band signal and digital carrier signal, and implementing multiplication thereof to generate a first and second transmission signal, the step of band-pass filtering the first and second transmission signal respectively, and the step of summing the filtered first and second transmission signal to generate a summation signal.

### BRIEF DESCRIPTION OF THE DRAWINGS

The following detailed description, given by way of example and not intended to limit the invention solely to the embodiments described herein, will best be understood in conjunction with the accompanying drawings, in which:

FIG. 1 illustrates the functional diagram and the basic elements of a digital communication system.

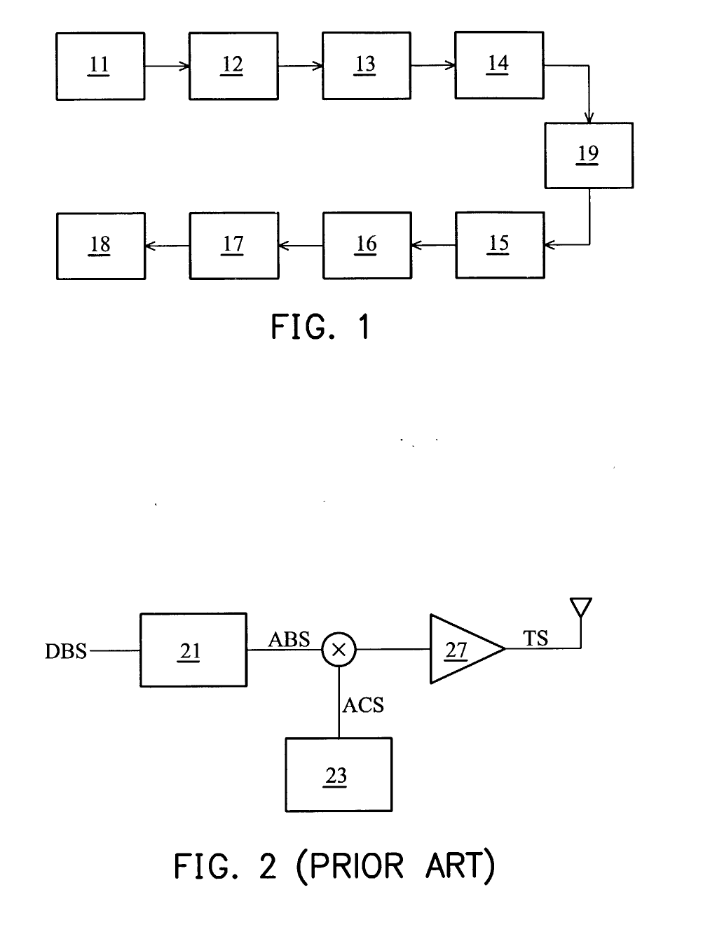

FIG. 2 is a block diagram showing a conventional RF transmitter used in the transmitting end of the digital communication system.

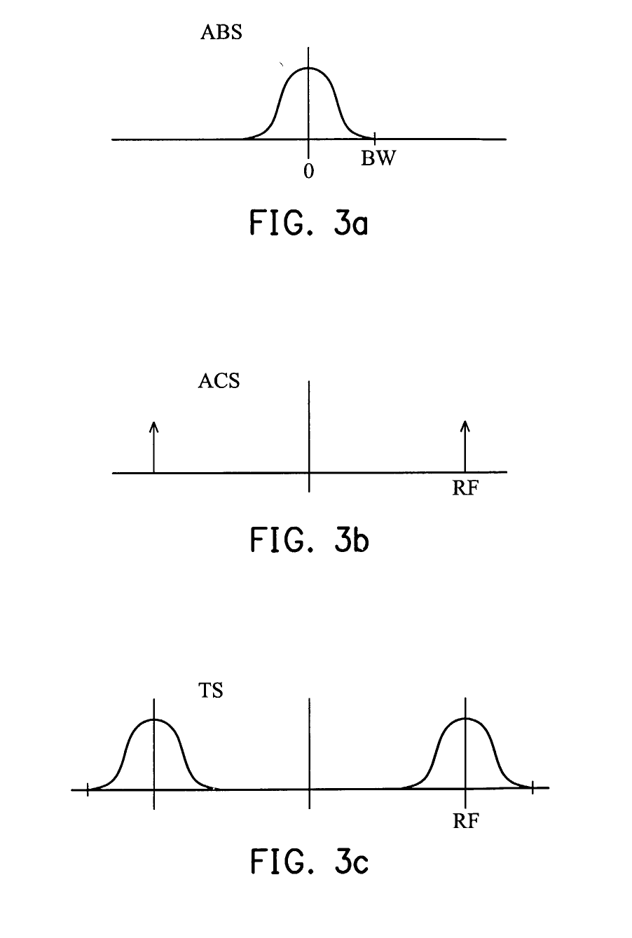

FIGS. 3a, 3b and 3c are diagrams showing the relation between the signals ABS, ACS and TS in frequency domain respectively.

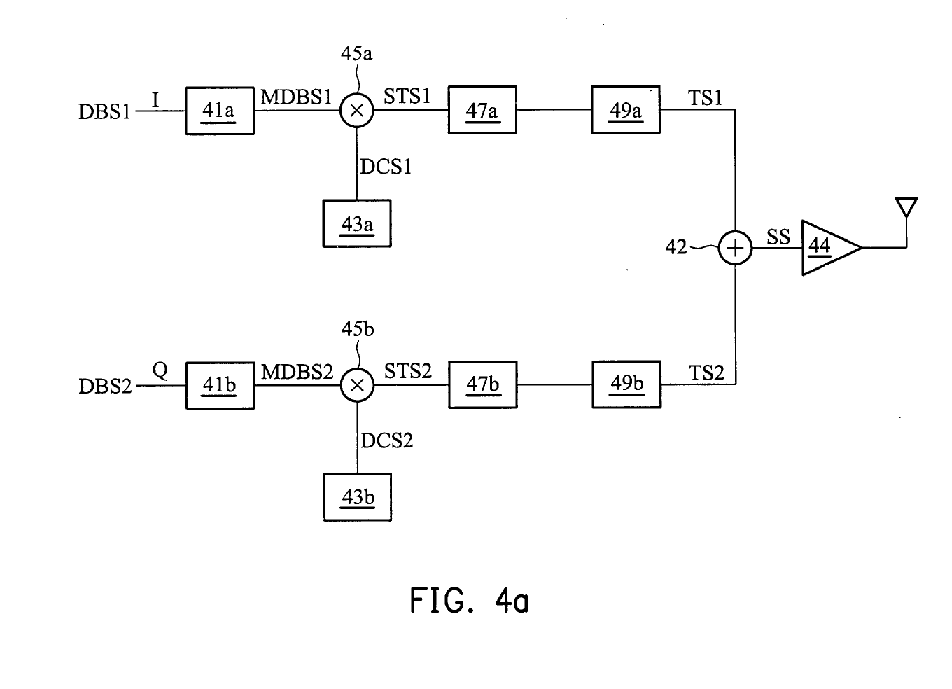

FIG. 4a is a block diagram showing an RF transmitter used in the transmitting end of the digital communication system according to one embodiment of the present invention.

FIG. 4b is a block diagram showing an RF transmitter used in the transmitting end of the digital communication system according to another embodiment of the present invention.

FIGS. 5a-5d are diagrams showing the relation between the signals MDBS, DCS, STS and TS in frequency domain respectively.

FIG. 6 is a flowchart of a method for RF transmission according to one embodiment of the present invention.

FIG. 7 is a diagram showing one embodiment of the modulator of the digital RF transmitter in FIG. 4.

FIGS. 8A and 8B shows one embodiment of the mixer circuit of the digital RF transmitter in FIG. 4 and its truth table.

### DETAILED DESCRIPTION OF THE INVENTION

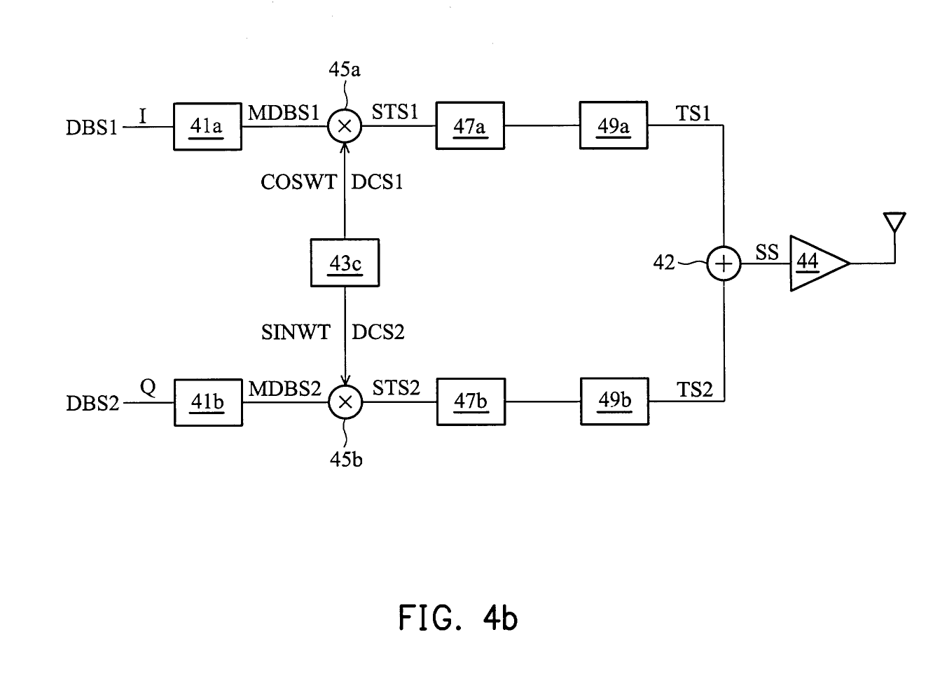

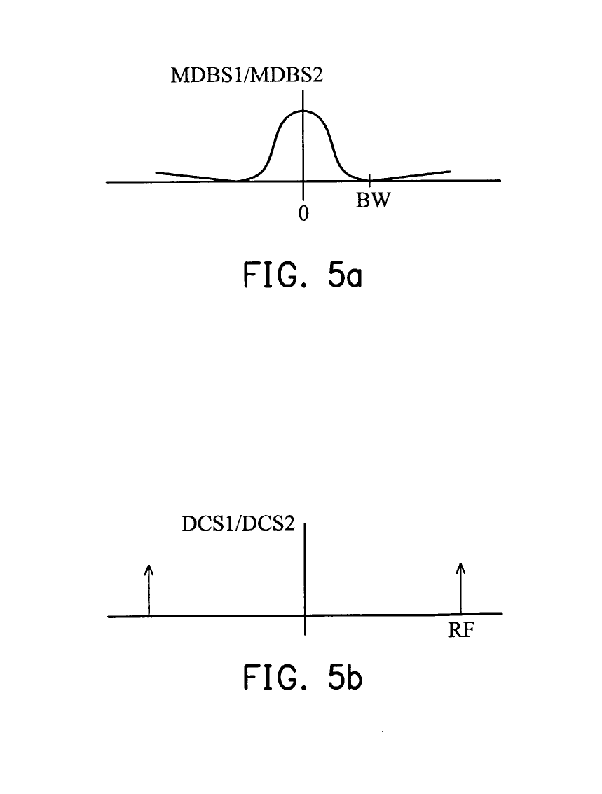

FIG. 4a is a block diagram showing an RF transmitter used in the transmitting end of the digital communication system according to one embodiment of the present invention. The RF transmitter comprises digital modulators 41a and 41b, local oscillator 43a and 43b, digital mixers 45a and 45b, switches 47a and 47b, band-pass filters 49a and 49b, an adder 42, and a power amplifier 44. The modulator 41a receives the digital base-band signal DBS1 from an I channel with a bandwidth baseband frequency f_{BB}, for example lower than 10 MHz, and modulates it into a modulated digital base-band signal MDBS1. The modulator 41a may comprise a noise-shaping quantization circuit or over-sampling circuit disclosed in U.S. Pat. No. 5,068,661, which provides a substantial improvement in S/N ratio, implements bit compression resulting in a digital signal having a high resolution converted to a digital signal having much lower resolution and reduced quantization noise level. Similarly, the modulator 41b receives the digital base-band signal DBS2 from a Q channel with a bandwidth baseband frequency f_{BB}, for example lower than 10 MHz, and modulates it into a modulated digital base-band signal MDBS2. The modulator 41b may also comprise a noise-shaping quantization circuit or over-sampling circuit disclosed in U.S. Pat. No. 5,068,661. There is a phase difference of 90° between the signals from the I and Q channel. The local oscillator 43a generates a digital carrier signal DCS1 with a Local oscillator frequency f_{LO}, for example 2.4 GHz or 5 GHz. Similarly, the local oscillator 43b generates a digital carrier signal DCS2 with a Local oscillator frequency f_{LO}. The mixer 45a receives the modulated digital base-band signal MDBS1 and the digital carrier signal DCS1, and then implements multiplication of the digital bits thereof. This causes a frequency shift of the signal MDBS1 in frequency domain and produces a semi-transmission signal STS1. Similarly, the mixer 45b receives the modulated digital base-band signal MDBS2 and the digital carrier signal DCS2, and then implements multiplication of the digital bits thereof. This also causes a frequency shift of the signal MDBS2 in frequency domain and produces a semi-transmission signal STS2. The semi-transmission signals STS1 and STS2 are sent to the switches 47a and 47b, and then filtered by the band-pass filters 49a and 49b, respectively. The filtered semi-transmission signals TS1 and TS2 are added by the digital adder 42. The adder 42 generates a summation signal SS sent to the power amplifier 44. The summation signal SS is amplified by the power amplifier 44 and then transmitted by an antenna.

FIG. 4b is a block diagram showing an RF transmitter used in the transmitting end of the digital communication system according to another embodiment of the present invention. The same elements in FIGS. 4a and 4b refer to the same symbols for clarity. It is noted that, in the RF digital transmitter shown in FIG. 4b, there is only one local oscillator 43c. The oscillator 43c generates the two digital carrier signals DCS1 and DCS2 with a phase difference of 90° respectively for I and Q channel.

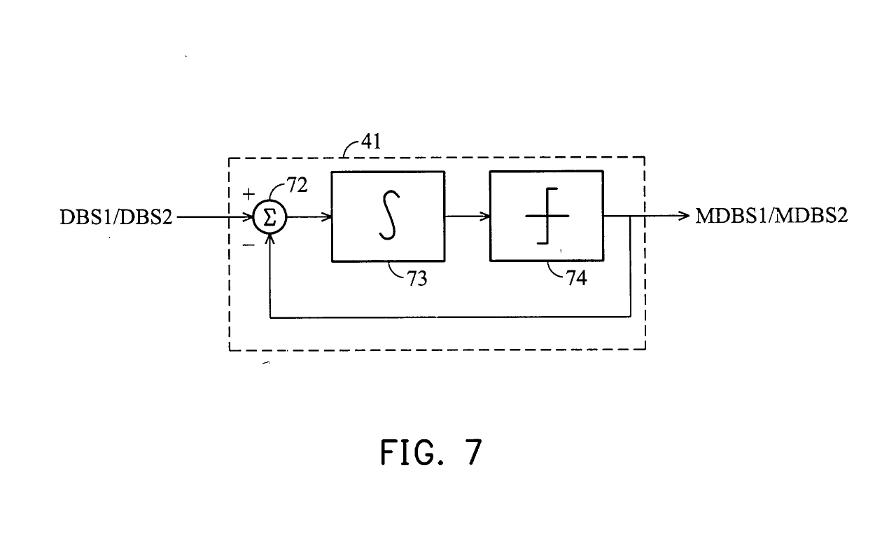

FIG. 7 is a block diagram showing one embodiment of the modulator 41a or 41b of the present invention. In this embodiment, the modulator 41a or 41b is a Sigma-Delta modulator, the Sigma-Delta modulator includes an adder 72, an accumulator 73 and a quantizer 74. The N-bit signal DBS1 or DBS2 into a one-bit signal with a frequency N×fₛ is input to the adder 72, wherein fₛ is the baseband sampling frequency of the signal DBS10R DBS2. Thus the frequency of output signal MDBS1 or MDBS2 is also N×fₛ. The circuit of the quantizer 74 can be an AND gate circuit wherein a high logic level is output when the voltage output from the accumulator 73 to the gate is lower than 0V and a low logic level is output when the voltage output from the accumulator 73 to the gate is higher than 0V.

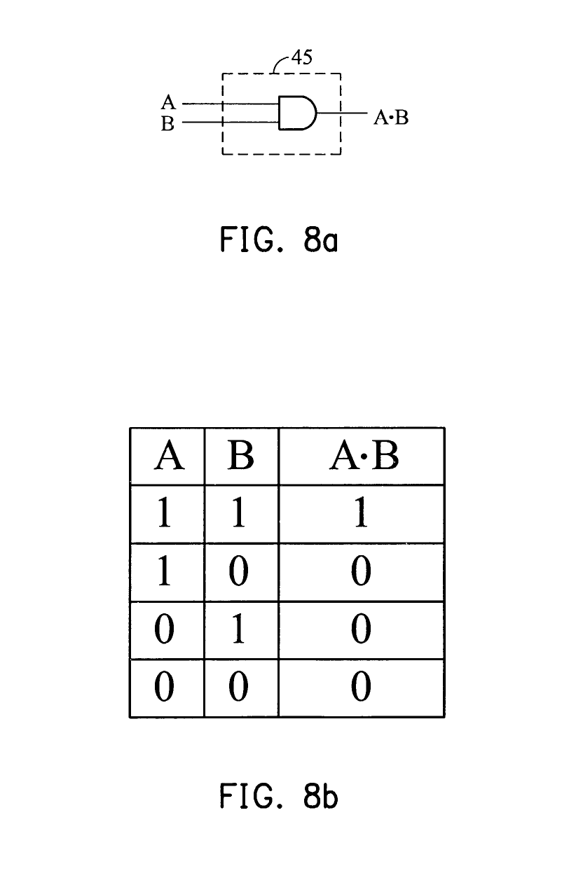

FIG. 8A is a block diagram showing one embodiment of the mixer 45a or 45b of the present invention. The mixer 45a or 45b may be an AND gate receiving bits A and B respectively from the signals MBDS1 or MDBS2, and DCS1 or DCS2. The output of the AND gate is a multiplication of A and B, as shown in the truth table of FIG. 8B.

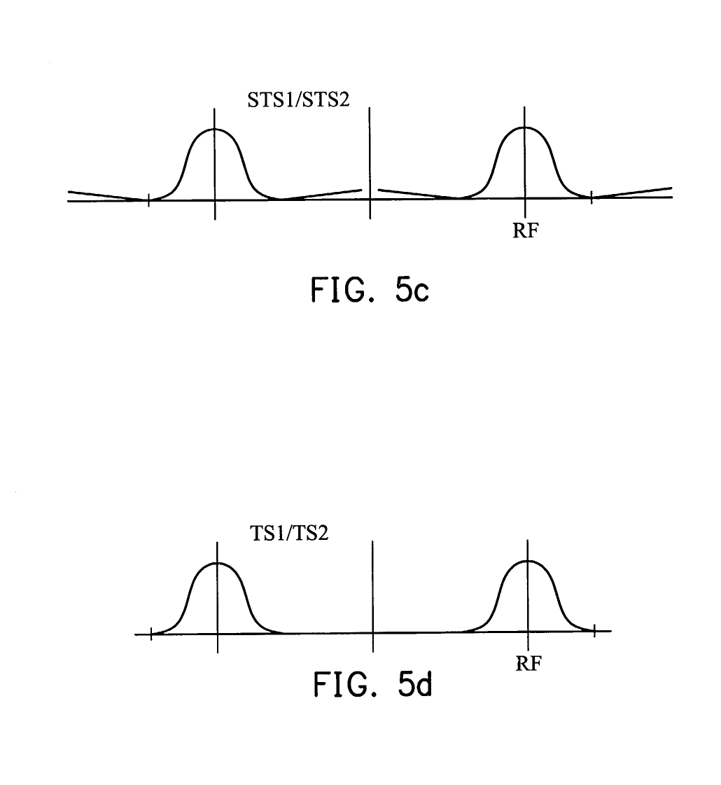

FIGS. 5a-5d are diagrams showing the relation between the signals MDBS1/MDBS2 DCS1/DCS2, STS1/STS2 and TS1/TS2 in frequency domain respectively. The signal MDBS1/MDBS2 has a bandwidth BW (lower than 10 MHz) and a central frequency 0. Additionally, the signal MDBS1/MDBS2 also has signal components at higher frequencies. The signal DCS1/DCS2 has a frequency RF (2.4 GHz or 5 GHz). After being mixed by the mixer 45a/45b, the signals MDBS1/MDBS2 and DCS1/DCS2 are integrated into the signal STS1/STS2 with the central frequency RF and bandwidth BW. The band-pass filter 49a/49b filters the signal STS1/STS2 and eliminates the signal components at the higher frequencies. Thus, the digital base-band signal DBS1/DBS2 is carried on the digital carrier signal DCS1/DCS2 and can be transmitted over a long distance.

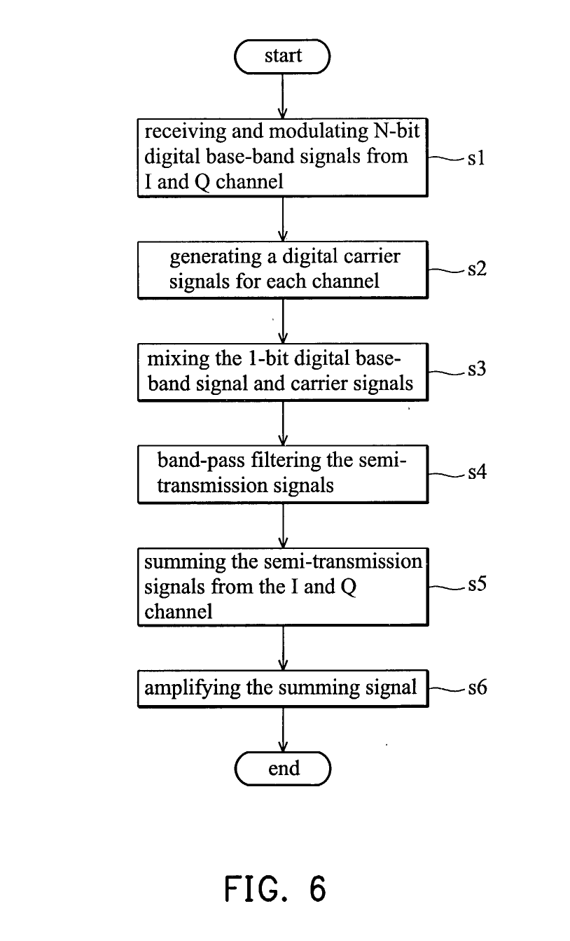

FIG. 6 is a flowchart of a method for RF transmission according to one embodiment of the invention.

In step S1, N-bit digital base-band signals from the I and Q channel with a frequency fₛ are received and modulated, and accordingly two 1-bit modulated digital base-band signals with a frequency N×fₛ are respectively generated. The modulation of the N-bit digital base-band signals may be Sigma-Delta modulation.

In step S2, digital carrier signals for the signals from the I and Q channel are generated.

In step S3, the 1-bit modulated digital base-band signals and digital carrier signals are received, and multiplication of the two received signals for each channel is implemented to respectively generate two semi-transmission signals.

In step S4, the semi-transmission signals are band-pass filtered.

In step S5, the two semi-transmission signals from the I and Q channel are added to generate a summation signal.

Finally, in step S6, the summation signal is amplified and transmitted through an antenna.

In conclusion, the present invention provides a two-channel digital RF transmitter. The digital RF transmitter is easier for circuit designers to work on. A mixer in the digital RF transmitter simply implements multiplication of digital bits from signals and does not cause nonlinear transformation.

While the invention has been described by way of example and in terms of the preferred embodiments, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An RF digital transmitter comprising:
a first and second modulator for receiving a first and second N-bit digital baseband frequency signal with a first frequency fs respectively from a first and second channel, and modulating the first and second digital base-band signals into a first and second 1-bit modulated baseband frequency signal with a second frequency which is M times fs;
a first and second local oscillator for generating a first and second digital carrier signal respectively;
a first and second digital mixer for receiving the first digital base-band and carrier signals, and the second digital base-band and carrier signals, and implementing multiplication of the first digital base-band and carrier signals, and the second digital base-band and carrier signals to generate a first and second transmission signal, respectively;
a first and second filter for band-pass filtering the first and second transmission signal respectively; and
an adder for summing the filtered first and second transmission signal to generate a summation signal.

2. The RF digital transmitter as claimed in claim 1 further comprising a power amplifier amplifying the summation signal.

3. The RF digital transmitter as claimed in claim 1, wherein the first and second modulator comprise a noise-shaping modulation means.

4. The RF digital transmitter as claimed in claim 1, wherein the first and second modulator comprise an over-sampling quantization means.

5. The RF digital transmitter as claimed in claim 1, wherein the first frequency is a sampling frequency.

6. The RF digital transmitter as claimed in claim 1, wherein the first and second modulator are I and Q modulator respectively, wherein I means in-phase and Q means quadrature phase.

7. A method for RF digital transmission comprising the steps of:
receiving and modulating a first and second digital base-band signal from a first and second channel respectively;
generating a first and second digital carrier signal;
receiving the first and second digital base-band and carrier signal, and implementing multiplication of the first digital base-band and carrier signals, and second digital base-band and carrier signals to generate a first and second transmission signal respectively;
band-pass filtering the first and second transmission signal respectively; and
summing the filtered first and second transmission signal to generate a summation signal.

8. The method as claimed in claim 7 further comprising the step of amplifying the summation signal.

9. The method as claimed in claim 7, wherein the modulation of the first and second digital base-band signal is Sigma-Delta modulation.

10. An RF digital transmitter comprising:
a first and second digital modulator receiving and modulating a first and second N-bit digital base-band signal with a frequency fₛ from a first and second channel, and generating a first and second 1-bit modulated digital base-band signal with a frequency N×fₛ, respectively;
a first and second local oscillator generating a first and second digital carrier signal;
a first and second digital mixer receiving the first and second 1-bit modulated digital base-band signal and digital carrier signal, and implementing multiplication thereof to generate a first and second transmission signal respectively;
a first and second filter for band-pass filtering the first and second transmission signal respectively; and
an adder for summing the filtered first and second transmission signal to generate a summation signal.

11. The RF digital transmitter as claimed in claim 10 further comprising a power amplifier amplifying the summation signal.

12. The RF digital transmitter as claimed in claim 10, wherein the first and second digital modulator are I and Q modulator respectively, wherein I means in-phase and Q means quadrature phase.

13. A method for RF digital transmission comprising the steps of:
receiving and modulating a first and second N-bit digital base-band signal with a frequency fₛ from a first and second channel, and generating a first and second 1-bit modulated digital base-band signal with a frequency N×fₛ;
generating a first and second digital carrier signal;
receiving the first and second 1-bit modulated digital base-band signal and digital carrier signal, and implementing multiplication thereof to generate a first and second transmission signal respectively;
band-pass filtering the first and second transmission signal respectively; and
summing the filtered first and second transmission signal to generate a summation signal.

14. The method as claimed in claim 13 further comprising the step of amplifying the summation signal.

15. A method for RF digital transmission comprising:
noise-shaping modulation means for receiving a first and second N-bit digital baseband frequency signal with a first frequency fs from a first and second channel, and modulating the first and second digital base-band signal into a first and second 1-bit modulated baseband frequency signal with a second frequency of M times fs;
local oscillation means for generating a first and second digital carrier signal;
digital mixing means for receiving the first and second digital base-band and carrier signal, and implementing multiplication of the first digital base-band and carrier signal, and the second digital base-band and carrier signal to generate a first and second transmission signal respectively;
a first and second filter means for band-pass filtering the first and second transmission signal respectively; and
an adding means for summing the filtered first and second transmission signal to generate a summation signal.

16. The method as claimed in claim 15 further comprising a power amplifying means for amplifying the digital summation signal.

17. The method as claimed in claim 15, wherein the first frequency is a sampling frequency.

18. The method as claimed in claim 15, wherein the noise-shaping modulation means comprises over-sampling means.

19. The method as claimed in claim 15, wherein the noise-shaping modulation means comprises noise-shaping quantization means.

20. An RF digital transmitter comprising:
a first and second noise-shaping modulator for receiving a first and second N-bit digital baseband frequency signal with a first frequency (sampling frequency) fs from a first and second channel respectively, and modulating the first and second digital base-band signal into a first and second 1-bit modulated baseband frequency signal with a second frequency of M times fs;
a first local oscillator for generating a first and second digital carrier signal;
digital mixing means for receiving the first and second digital base-band and carrier signal, and implementing multiplication of the first and second digital base-band and carrier signal to generate a first and second transmission signal respectively;
a first and second filter for band-pass filtering the first and second transmission signal respectively; and
a digital adder for summing the filtered first and second transmission signal to generate a summation signal.

21. The RF digital transmitter as claimed in claim 20 further comprising a switching power amplifier means for amplifying the digital summation signal.

22. The RF digital transmitter as claimed in claim 20, wherein the modulation of the first and second digital base-band signal comprises a Sigma-Delta modulation.

23. The RF digital transmitter as claimed in claim 20, wherein the first and second noise-shaping modulator comprise over-sampling means.

24. The RF digital transmitter as claimed in claim 20, wherein the first and second noise-shaping modulator comprise noise-shaping quantization means.

25. The RF digital transmitter as claimed in claim 20, wherein the first and second noise-shaping modulator are I and Q modulator respectively, wherein I means in-phase and Q means quadrature phase.
